(19) United States
(12) Patent Application Publication
(10) Pub. No.: US 2025/0119245 A1
(43) Pub. Date: Apr. 10, 2025

(54) METHOD, TRANSMISSION DEVICE, PROCESSING DEVICE, AND STORAGE MEDIUM FOR TRANSMITTING SEMANTIC DATA, AND METHOD AND RECEPTION DEVICE FOR RECEIVING SEMANTIC DATA IN WIRELESS COMMUNICATION SYSTEM

(71) Applicant: LG ELECTRONICS INC., Seoul (KR)

(72) Inventors: Ikjoo JUNG, Seoul (KR); Sangrim LEE, Seoul (KR); Kyungho LEE, Seoul (KR); Kijun JEON, Seoul (KR); Taehyun LEE, Seoul (KR)

(21) Appl. No.: 18/716,470

(22) PCT Filed: Dec. 7, 2021
(86) PCT No.: PCT/KR2021/018465

§ 371 Date: Dec. 16, 2024

(51) Int. Cl. H04L 1/22

(52) U.S. Cl. CPC H04L 1/22

(57) ABSTRACT

In a wireless communication system, a transmission device may transmit semantic data. The transmission device may: transmit a first semantic message including the semantic data to a reception device; receive a first semantic feedback for the first semantic message from the reception device; and on the basis that a result included in the semantic feedback does not agree with the result intended by the transmission device through the first semantic message, transmit a second semantic message including first redundancy data related to the semantic data to the reception device.

### CROSS-REFERENCE TO RELATED APPLICATIONS

This application is a National Phase application under 35 U.S.C. 371 of International Application No. PCT/KR2021/018465, filed on Dec. 7, 2021, the contents of which are incorporated by reference herein in their entirety.

### TECHNICAL FIELD

The present disclosure relates to a wireless communication system.

### BACKGROUND

A variety of technologies, such as machine-to-machine (M2M) communication, machine type communication (MTC), and a variety of devices demanding high data throughput, such as smartphones and tablet personal computers (PCs), have emerged and spread. Accordingly, the volume of data throughput demanded to be processed in a cellular network has rapidly increased. In order to satisfy such rapidly increasing data throughput, carrier aggregation technology or cognitive radio technology for efficiently employing more frequency bands and multiple input multiple output (MIMO) technology or multi-base station (BS) cooperation technology for raising data capacity transmitted on limited frequency resources have been developed.

As more and more communication devices have required greater communication capacity, there has been a need for enhanced mobile broadband (eMBB) communication relative to legacy radio access technology (RAT). In addition, massive machine type communication (mMTC) for providing various services at anytime and anywhere by connecting a plurality of devices and objects to each other is one main issue to be considered in next-generation (e.g., 5G) communication.

Communication system design considering services/user equipment (UEs) sensitive to reliability and latency is also under discussion. The introduction of next-generation RAT is being discussed in consideration of eMBB communication, mMTC, ultra-reliable and low-latency communication (URLLC), and the like.

While 5G communication is still under development, there is an increasing demand for higher data rates to accommodate new services such as virtual reality and autonomous driving.

### SUMMARY

As new radio communication technology has been introduced, the number of UEs to which a BS should provide services in a prescribed resource region is increasing and the volume of data and control information that the BS transmits/receives to/from the UEs to which the BS provides services is also increasing. Since the amount of resources available to the BS for communication with the UE(s) is limited, a new method for the BS to efficiently receive/transmit uplink/downlink data and/or uplink/downlink control information from/to the UE(s) using the limited radio resources is needed. In other words, due to increase in the density of nodes and/or the density of UEs, a method for efficiently using high-density nodes or high-density UEs for communication is needed.

A method to efficiently support various services with different requirements in a wireless communication system is also needed.

Overcoming delay or latency is an important challenge to applications, performance of which is sensitive to delay/latency.

There is a need for a method of efficiently performing semantic communication.

The objects to be achieved with the present disclosure are not limited to what has been particularly described hereinabove and other objects not described herein will be more clearly understood by persons skilled in the art from the following detailed description.

According to an aspect of the present disclosure, provided is a method of transmitting semantic data by a transmitting device in a wireless communication system. The method includes transmitting a first semantic message including the semantic data to a receiving device, receiving first semantic feedback for the first semantic message from the receiving device, and transmitting a second semantic message including first redundancy data related to the semantic data to the receiving device based on that a result included in the first semantic feedback does not match a result intended by the transmitting device through the first semantic message.

According to another aspect of the present disclosure, provided is a transmitting device for transmitting semantic data in a wireless communication system. The transmitting device includes at least one transceiver, at least one processor, and at least one computer memory operably connected to the at least one processor and configured to store instructions that, when executed, cause the at least one processor to perform operations. The operations include transmitting a first semantic message including the semantic data to a receiving device, receiving first semantic feedback for the first semantic message from the receiving device, and transmitting a second semantic message including first redundancy data related to the semantic data to the receiving device based on that a result included in the first semantic feedback does not match a result intended by the transmitting device through the first semantic message.

According to another aspect of the present disclosure, provided is a processing device for a communication device. The processing device includes at least one processor, and at least one computer memory operably connected to the at least one processor and configured to store instructions that, when executed, cause the at least one processor to perform operations. The operations include transmitting a first semantic message including semantic data to a receiving device, receiving first semantic feedback for the first semantic message from the receiving device, and transmitting a second semantic message including first redundancy data related to the semantic data to the receiving device based on that a result included in the first semantic feedback does not match a result intended by the transmitting device through the first semantic message.

According to another aspect of the present disclosure, provided is a computer-readable storage medium. The storage medium stores at least one program code including instructions that, when executed, cause the at least one processor to perform operations. The operations include transmitting a first semantic message including semantic data to a receiving device, receiving first semantic feedback for the first semantic message from the receiving device, and transmitting a second semantic message including first redundancy data related to the semantic data to the receiving device based on that a result included in the first semantic feedback does not match a result intended by the transmitting device through the first semantic message.

According to each aspect of the present disclosure, the method may further include receiving second semantic feedback for the second semantic message from the receiving device.

According to each aspect of the present disclosure, the method may further include transmitting a new semantic message including new semantic data based on that a result included in the first semantic feedback matches a result intended by the transmitting device through the first semantic message.

According to each aspect of the present disclosure, transmitting the second semantic message including the first redundancy data related to the semantic data to the receiving device may include generating a plurality of redundancy data related to the semantic data in predetermined units, and selecting redundancy data with a highest similarity to the semantic data included in the first semantic message from among the plurality of redundancy data as the first redundancy data.

According to each aspect of the present disclosure, the method may further include receiving a configuration for semantic communication. The configuration may include the predetermined units.

According to each aspect of the present disclosure, the configuration may include information about a similarity function for calculation of a similarity.

According to another aspect of the present disclosure, provided is a method of receiving semantic data by a receiving device in a wireless communication system. The method may include receiving a first semantic message including the semantic data from a transmitting device, performing a task based on the semantic data, and transmitting first semantic feedback for the first semantic message to the transmitting device, wherein the first semantic feedback includes a result of a task performed based on the semantic data.

According to another aspect of the present disclosure, provided is a receiving device for receiving semantic data in a wireless communication system. The receiving device includes at least one transceiver, at least one processor, and at least one computer memory operably connected to the at least one processor and configured to store instructions that, when executed, cause the at least one processor to perform operations. The operations include receiving a first semantic message including the semantic data from a transmitting device, performing a task based on the semantic data, and transmitting first semantic feedback for the first semantic message to the transmitting device, wherein the first semantic feedback includes a result of a task performed based on the semantic data.

According to each aspect of the present disclosure, the receiving device may receive a second semantic message including first redundancy data related to the semantic data, perform a task related to the semantic data based on the semantic data and the first redundancy data, and transmit second semantic feedback including the result of the task performed based on the semantic data and the first redundancy data to the transmitting device.

The foregoing solutions are merely a part of the examples of the present disclosure and various examples into which the technical features of the present disclosure are incorporated may be derived and understood by persons skilled in the art from the following detailed description.

According to implementations of the present disclosure, a wireless communication signal may be efficiently transmitted/received. Accordingly, the overall throughput of a wireless communication system may be improved.

According to implementations of the present disclosure, a wireless communication system may efficiently support various services with different requirements.

According to implementations of the present disclosure, delay/latency occurring during wireless communication between communication devices may be reduced.

According to implementations of the present disclosure, semantic communication may be efficiently performed.

The effects according to the present disclosure are not limited to what has been particularly described hereinabove and other effects not described herein will be more clearly understood by persons skilled in the art related to the present disclosure from the following detailed description.

### BRIEF DESCRIPTION OF THE DRAWINGS

The accompanying drawings, which are included to provide a further understanding of the present disclosure, illustrate examples of implementations of the present disclosure and together with the detailed description serve to explain implementations of the present disclosure:

FIG. 1 illustrates an example of a communication system 1 to which implementations of the present disclosure are applied;

FIG. 2 is a block diagram illustrating examples of communication devices capable of performing a method according to the present disclosure;

FIG. 3 illustrates another example of a wireless device capable of performing implementation(s) of the present disclosure:

FIG. 4 illustrates a perceptron structure used in an artificial neural network:

FIG. 5 illustrates a multilayer perceptron structure:

FIG. 6 illustrates the structure of a convolutional neural network (CNN);

FIG. 7 illustrates a filtering operation in a CNN:

FIG. 8 illustrates a three-level communication model to which implementations of the present disclosure are applicable:

FIG. 9 is a diagram for explaining the characteristics of semantic communication:

FIG. 10 shows an example of a semantic communication model considering semantic noise:

FIG. 11 is a diagram for helping understand semantic errors:

FIG. 12 illustrates operations performed at a source according to some implementations of the present disclosure:

FIG. 13 illustrates operations performed at a destination according to some implementations of the present disclosure:

FIG. 14 is diagram for explaining some implementations of the present disclosure using text data as an example; and

FIGS. 15 to 18 are diagrams for explaining some implementations of the present disclosure using graph data as an example.

### DETAILED DESCRIPTION

Hereinafter, implementations according to the present disclosure will be described in detail with reference to the accompanying drawings. The detailed description, which will be given below with reference to the accompanying drawings, is intended to explain exemplary implementations of the present disclosure, rather than to show the only implementations that may be implemented according to the present disclosure. The following detailed description includes specific details in order to provide a thorough understanding of the present disclosure. However, it will be apparent to those skilled in the art that the present disclosure may be practiced without such specific details.

In some instances, known structures and devices may be omitted or may be shown in block diagram form, focusing on important features of the structures and devices, so as not to obscure the concept of the present disclosure. The same reference numbers will be used throughout the present disclosure to refer to the same or like parts.

A technique, a device, and a system described below may be applied to a variety of wireless multiple access systems. The multiple access systems may include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, a multi-carrier frequency division multiple access (MC-FDMA) system, etc. CDMA may be implemented by radio technology such as universal terrestrial radio access (UTRA) or CDMA2000. TDMA may be implemented by radio technology such as global system for mobile communications (GSM), general packet radio service (GPRS), enhanced data rates for GSM evolution (EDGE) (i.e., GERAN), etc. OFDMA may be implemented by radio technology such as institute of electrical and electronics engineers (IEEE) 802.11 (Wi-Fi), IEEE 802.16 (WiMAX), IEEE 802.20, evolved-UTRA (E-UTRA), etc. UTRA is part of universal mobile telecommunications system (UMTS) and 3rd generation partnership project (3GPP) long-term evolution (LTE) is part of E-UMTS using E-UTRA. 3GPP LTE adopts OFDMA on downlink (DL) and adopts SC-FDMA on uplink (UL). LTE-advanced (LTE-A) is an evolved version of 3GPP LTE.

For convenience of description, description will be given under the assumption that the present disclosure is applied to LTE and/or new RAT (NR). However, the technical features of the present disclosure are not limited thereto. For example, although the following detailed description is given based on mobile communication systems corresponding to 3GPP LTE/NR systems, the mobile communication systems are applicable to other arbitrary mobile communication systems except for matters that are specific to the 3GPP LTE/NR system.

For terms and techniques that are not described in detail among terms and techniques used in the present disclosure, reference may be made to 3GPP based standard specifications, for example, 3GPP TS 36.211, 3GPP TS 36.212, 3GPP TS 36.213, 3GPP TS 36.321, 3GPP TS 36.300, 3GPP TS 36.331, 3GPP TS 37.213, 3GPP TS 38.211, 3GPP TS 38.212, 3GPP TS 38.213, 3GPP TS 38.214, 3GPP TS 38.300, 3GPP TS 38.331, etc.

In examples of the present disclosure described later, if a device “assumes” something, this may mean that a channel transmission entity transmits a channel in compliance with the corresponding “assumption”. This also may mean that a channel reception entity receives or decodes the channel in the form of conforming to the “assumption” on the premise that the channel has been transmitted in compliance with the “assumption”.

In the present disclosure, a user equipment (UE) may be fixed or mobile. Each of various devices that transmit and/or receive user data and/or control information by communicating with a base station (BS) may be the UE. The term UE may be referred to as terminal equipment, mobile station (MS), mobile terminal (MT), user terminal (UT), subscriber station (SS), wireless device, personal digital assistant (PDA), wireless modem, handheld device, etc. In the present disclosure, the term user is used to refer to a UE. In the present disclosure, a BS refers to a fixed station that communicates with a UE and/or another BS and exchanges data and control information with a UE and another BS. The term BS may be referred to as advanced base station (ABS), Node-B (NB), evolved Node-B (eNB), base transceiver system (BTS), access point (AP), processing server (PS), etc. Particularly, a BS of a universal terrestrial radio access (UTRAN) is referred to as an NB, a BS of an evolved-UTRAN (E-UTRAN) is referred to as an eNB, and a BS of new radio access technology network is referred to as a gNB. Hereinbelow, for convenience of description, the NB, eNB, or gNB will be referred to as a BS regardless of the type or version of communication technology.

In the present disclosure, a transmission and reception point (TRP) refers to a fixed point capable of transmitting/receiving a radio signal to/from a UE by communication with the UE. Various types of BSs may be used as TRPs regardless of the names thereof. For example, a BS, NB, eNB, pico-cell eNB (PeNB), home eNB (HeNB), relay, repeater, etc. may be a TRP. Furthermore, a TRP may not be a BS. For example, a radio remote head (RRH) or a radio remote unit (RRU) may be a TRP. Generally, the RRH and RRU have power levels lower than that of the BS. Since the RRH or RRU (hereinafter, RRH/RRU) is connected to the BS through a dedicated line such as an optical cable in general, cooperative communication according to the RRH/RRU and the BS may be smoothly performed relative to cooperative communication according to BSs connected through a wireless link. At least one antenna is installed per TRP. An antenna may refer to a physical antenna port or refer to a virtual antenna or an antenna group. The TRP may also be called a point.

In the present disclosure, a cell refers to a specific geographical area in which one or more TRPs provide communication services. Accordingly, in the present disclosure, communication with a specific cell may mean communication with a BS or a TRP providing communication services to the specific cell. A DL/UL signal of the specific cell refers to a DL/UL signal from/to the BS or the TRP providing communication services to the specific cell. A cell providing UL/DL communication services to a UE is especially called a serving cell. Furthermore, channel status/quality of the specific cell refers to channel status/quality of a channel or a communication link generated between the BS or the TRP providing communication services to the specific cell and the UE. In 3GPP-based communication systems, the UE may measure a DL channel state from a specific TRP using cell-specific reference signal(s) (CRS(s)) transmitted on a CRS resource and/or channel state information reference signal(s) (CSI-RS(s)) transmitted on a CSI-RS resource, allocated to the specific TRP by antenna port(s) of the specific TRP.

A 3GPP-based communication system uses the concept of a cell in order to manage radio resources, and a cell related with the radio resources is distinguished from a cell of a geographic area.

The “cell” of the geographic area may be understood as coverage within which a TRP may provide services using a carrier, and the “cell” of the radio resources is associated with bandwidth (BW), which is a frequency range configured by the carrier. Since DL coverage, which is a range within which the TRP is capable of transmitting a valid signal, and UL coverage, which is a range within which the TRP is capable of receiving the valid signal from the UE, depend upon a carrier carrying the signal, coverage of the TRP may also be associated with coverage of the “cell” of radio resources used by the TRP. Accordingly, the term “cell” may be used to indicate service coverage by the TRP sometimes, radio resources at other times, or a range that a signal using the radio resources may reach with valid strength at other times.

In 3GPP communication standards, the concept of the cell is used in order to manage radio resources. The “cell” associated with the radio resources is defined by a combination of DL resources and UL resources, that is, a combination of a DL component carrier (CC) and a UL CC. The cell may be configured by the DL resources only or by the combination of the DL resources and the UL resources. If carrier aggregation is supported, linkage between a carrier frequency of the DL resources (or DL CC) and a carrier frequency of the UL resources (or UL CC) may be indicated by system information. In this case, the carrier frequency may be equal to or different from a center frequency of each cell or CC.

In a wireless communication system, the UE receives information on DL from the BS and the UE transmits information on UL to the BS. The information that the BS and UE transmit and/or receive includes data and a variety of control information and there are various physical channels according to types/usage of the information that the UE and the BS transmit and/or receive.

The 3GPP-based communication standards define DL physical channels corresponding to resource elements carrying information originating from a higher layer and DL physical signals corresponding to resource elements which are used by the physical layer but do not carry the information originating from the higher layer. For example, a physical downlink shared channel (PDSCH), a physical broadcast channel (PBCH), a physical multicast channel (PMCH), a physical control format indicator channel (PCFICH), a physical downlink control channel (PDCCH), etc. are defined as the DL physical channels, and a reference signal (RS) and a synchronization signal (SS) are defined as the DL physical signals. The RS, which is also referred to as a pilot, represents a signal with a predefined special waveform known to both the BS and the UE. For example, a demodulation reference signal (DMRS), a channel state information RS (CSI-RS), etc. are defined as DL RSs. The 3GPP-based communication standards define UL physical channels corresponding to resource elements carrying information originating from the higher layer and UL physical signals corresponding to resource elements which are used by the physical layer but do not carry the information originating from the higher layer. For example, a physical uplink shared channel (PUSCH), a physical uplink control channel (PUCCH), and a physical random access channel (PRACH) are defined as the UL physical channels, and a DMRS for a UL control/data signal, a sounding reference signal (SRS) used for UL channel measurement, etc. are defined.

In the present disclosure, the PDCCH refers to a set of time-frequency resources (e.g., a set of resource elements (REs)) that carry downlink control information (DCI), and the PDSCH refers to a set of time-frequency resources (e.g., a set of REs) that carry DL data. The PUCCH, PUSCH, and PRACH refer to a set of time-frequency resources (i.e., a set of REs) that carry uplink control information (UCI), UL data, and random access signals, respectively. In the following description, the meaning of “The UE transmits/receives the PUCCH/PUSCH/PRACH” is that the UE transmits/receives the UCI/UL data/random access signals on or through the PUCCH/PUSCH/PRACH, respectively. In addition, the meaning of “the BS transmits/receives the PBCH/PDCCH/PDSCH” is that the BS transmits the broadcast information/DCI/DL data on or through a PBCH/PDCCH/PDSCH, respectively.

In the present disclosure, a radio resource (e.g., a time-frequency resource) scheduled or configured for the UE by the BS for transmission or reception of PUCCH/PUSCH/PDSCH is also referred to as a PUCCH/PUSCH/PDSCH resource.

Since a communication device receives an SS/PBCH resource block (SSB), DMRS, CSI-RS, PBCH, PDCCH, PDSCH, PUSCH, and/or PUCCH in the form of radio signals on a cell, the communication device may not select and receive radio signals including only a specific physical channel or a specific physical signal through a radio frequency (RF) receiver, or may not select and receive radio signals without a specific physical channel or a specific physical signal through the RF receiver. In actual operations, the communication device receives radio signals on the cell via the RF receiver, converts the radio signals, which are RF band signals, into baseband signals, and then decodes physical signals and/or physical channels in the baseband signals using one or more processors. Thus, in some implementations of the present disclosure, not receiving physical signals and/or physical channels may mean that a communication device does not attempt to restore the physical signals and/or physical channels from radio signals, for example, does not attempt to decode the physical signals and/or physical channels, rather than that the communication device does not actually receive the radio signals including the corresponding physical signals and/or physical channels.

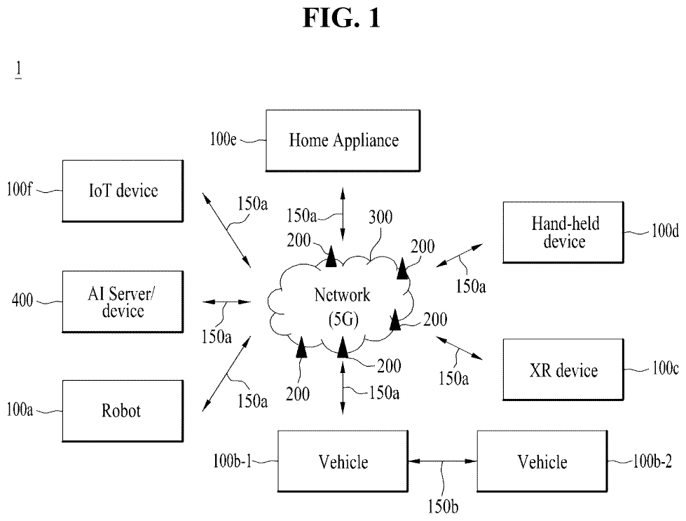

FIG. 1 illustrates an example of a communication system 1 to which implementations of the present disclosure are applied. Referring to FIG. 1, the communication system 1 applied to the present disclosure includes wireless devices, BSs, and a network. Here, the wireless devices represent devices performing communication using radio access technology (RAT) (e.g., 5G New RAT (NR) or LTE (e.g., E-UTRA), 6G) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Here, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may also be implemented as wireless devices and a specific wireless may operate as a BS/network node with respect to another wireless device.

The wireless devices 100a to 100f may be connected to a network 300 via BSs 200. AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network or 6G network to be introduced in the future. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. vehicle-to-vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f and the BSs 200 and between the wireless devices 100a to 100f). Here, the wireless communication/connections such as UL/DL communication 150a and sidelink communication 150b (or, device-to-device (D2D) communication) may be established by various RATs. The wireless devices and the BSs/wireless devices may transmit/receive radio signals to/from each other through the wireless communication/connections 150a and 150b. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

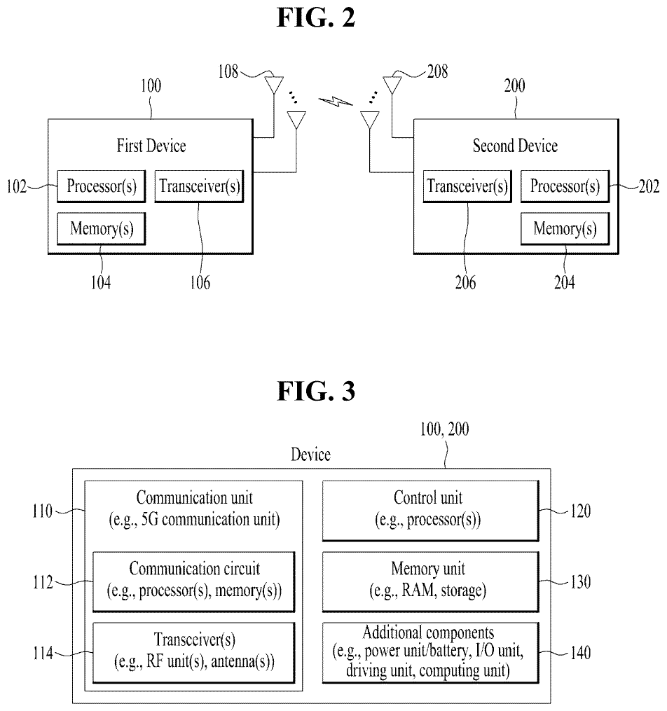

FIG. 2 is a block diagram illustrating examples of communication devices capable of performing a method according to the present disclosure. Referring to FIG. 2, a first wireless device 100 and a second wireless device 200 may transmit and/or receive radio signals through a variety of RATs. Here, {the first wireless device 100 and the second wireless device 200} may correspond to {the wireless device 100x and the BS 200} and/or {the wireless device 100x and the wireless device 100x} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the below-described/proposed functions, procedures, and/or methods. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may perform a part or all of processes controlled by the processor(s) 102 or store software code including instructions for performing the below-described/proposed procedures and/or methods. Here, the processor(s) 102 and the memory(s) 104 may be a part of a communication modem/circuit/chip designed to implement wireless communication technology. The transceiver(s) 106 may be connected to the processor(s) 102 and transmit and/or receive radio signals through one or more antennas 108. Each of the transceiver(s) 106 may include a transmitter and/or a receiver. The transceiver(s) 106 is used interchangeably with radio frequency (RF) unit(s). In the present disclosure, the wireless device may represent the communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the afore/below-described/proposed functions, procedures, and/or methods. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may perform a part or all of processes controlled by the processor(s) 202 or store software code including instructions for performing the afore/below-described/proposed procedures and/or methods. Here, the processor(s) 202 and the memory(s) 204 may be a part of a communication modem/circuit/chip designed to implement wireless communication technology. The transceiver(s) 206 may be connected to the processor(s) 202 and transmit and/or receive radio signals through one or more antennas 208. Each of the transceiver(s) 206 may include a transmitter and/or a receiver. The transceiver(s) 206 is used interchangeably with RF unit(s). In the present disclosure, the wireless device may represent the communication modem/circuit/chip.

The wireless communication technology implemented in the wireless devices 100 and 200 of the present disclosure may include narrowband Internet of Things for low-power communication as well as LTE, NR, and 6G communications. For example, NB-IoT technology may be an example of Low Power Wide Area Network (LPWAN) technology, and may be implemented by, but is limited to, standards such as LTE Cat NB1 and/or LTE Cat NB2. Additionally or alternatively, the wireless communication technology implemented in the wireless devices XXX and YYY of the present disclosure may perform communication based on the LTE-M technology. For example, the LTE-M technology may be an example of the LPWAN technology, and may be called by various names such as enhanced machine type communication (eMTC). For example, the LTE-M technology may be implemented by, but is not limited to, at least one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M. Additionally or alternatively, the wireless communication technology implemented in the wireless devices XXX and YYY of the present disclosure may include, but is not limited to, at least one of ZigBee, Bluetooth, and Low Power Wide Area Network (LPWAN) considering low-power communication. For example, the ZigBee technology may create personal area networks (PAN) related to small/low-power digital communications based on various standards such as IEEE 802.15.4, and may be called by various names.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as a physical (PHY) layer, medium access control (MAC) layer, a radio link control (RLC) layer, a packet data convergence protocol (PDCP) layer, radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in the present disclosure. The one or more processors 102 and 202 may generate messages, control information, data, or information according to the functions, procedures, proposals, and/or methods disclosed in the present disclosure. The one or more processors 102 and 202 may generate signals (e.g., baseband signals) including PDUs, SDUs, messages, control information, data, or information according to the functions, procedures, proposals, and/or methods disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The functions, procedures, proposals, and/or methods disclosed in the present disclosure may be implemented using firmware or software, and the firmware or software may be configured to include the modules, procedures, or functions. Firmware or software configured to perform the functions, procedures, proposals, and/or methods disclosed in the present disclosure may be included in the one or more processors 102 and 202 or stored in the one or more memories 104 and 204 so as to be driven by the one or more processors 102 and 202. The functions, procedures, proposals, and/or methods disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, commands, and/or instructions. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208. The one or more transceivers 106 and 206 may be configured to transmit and receive user data, control information, and/or radio signals/channels, mentioned in the functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 3 illustrates another example of a wireless device capable of performing implementation(s) of the present disclosure. Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 2. For example, the transceiver(s) 114 may include the one or more transceivers 106 and 206 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast UE, a hologram device, a public safety device, an MTC device, a medicine device, a fintech device (or a finance device), a security device, a climate/environment device, the AI server/device (400 of FIG. 1), the BS (200 of FIG. 1), a network node, etc. The wireless device may be used in a mobile or fixed place according to a use-case/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read-only memory (ROM)), a flash memory, a transitory memory, a non-transitory memory, and/or a combination thereof.

In the present disclosure, the at least one memory (e.g., 104 or 204) may store instructions or programs, and the instructions or programs may cause, when executed, at least one processor operably connected to the at least one memory to perform operations according to some embodiments or implementations of the present disclosure.

In the present disclosure, a computer readable (non-transitory) storage medium may store at least one instruction or program, and the at least one instruction or program may cause, when executed by at least one processor, the at least one processor to perform operations according to some embodiments or implementations of the present disclosure.

In the present disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the present disclosure.

In the present disclosure, a computer program may include program code stored on at least one computer-readable (non-transitory) storage medium and, when executed, configured to perform operations according to some implementations of the present disclosure or cause at least one processor to perform the operations according to some implementations of the present disclosure. The computer program may be provided in the form of a computer program product. The computer program product may include at least one computer-readable (non-transitory) storage medium

A communication device of the present disclosure includes at least one processor; and at least one computer memory operably connected to the at least one processor and configured to store instructions for causing, when executed, the at least one processor to perform operations according to example(s) of the present disclosure described later.

Wireless communication systems are extensively deployed to provide various types of communication services such as voice and data. The demand for higher data rates is increasing to accommodate incoming new services and/or scenarios where the virtual and real worlds blend. To address these ever-growing demands, new communication technologies beyond 5G are required. New communication technologies beyond 6G systems (hereinafter referred to as 6G) aim to achieve (i) extremely high data speeds per device, (ii) very large number of connected devices, (iii) global connectivity, (iv) ultra-low latency, (v) reducing energy consumption of battery-free IoT devices, (vi) ultra-reliable connections, (vii) connected intelligence with machine learning capabilities. In the 6G system, the following technologies are being considered: artificial intelligence (AI), terahertz (THz) communication, optical wireless communication (OWC), free space optics (FSO) backhaul network, massive multiple-input multiple-output (MIMO) technology, blockchain, three-dimensional (3D) networking, quantum communication, unmanned aerial vehicle (UAV), cell-free communication, integration of wireless information and energy transmission, integration of sensing and communication, integration of access backhaul networks, hologram beamforming, big data analysis, large intelligent surface (LIS), and so on.

In particular, there has been a rapid increase in attempts to integrate AI into communication systems. Methods being attempted in relation to AI may be broadly categorized into two: AI for communications (AI4C), which uses AI to enhance communication performance, and communications for AI (C4AI), which develops communication technologies to support AI. In the AI4C field, designs have been attempted to replace the roles of channel encoders/decoders, modulators/demodulators, or channel equalizers with end-to-end autoencoders or neural networks. In the C4AI field, as one type of distributed learning, federated learning involves updating a common prediction model by sharing only the weights and gradients of models with the server without sharing device raw data while protecting privacy.

Introducing AI into communications may simplify and enhance real-time data transmission. AI may use numerous analytics to determine a method of performing complex target tasks. In other words, AI may increase efficiency and reduce processing delays.

Time-consuming tasks such as handover, network selection, and resource scheduling may be instantly performed using AI. AI may also play a significant role in machine-to-machine, machine-to-human, and human-to-machine communications. AI-based communication systems may be supported by meta-materials, intelligent architectures, intelligent networks, intelligent devices, intelligence cognitive radio, self-sustaining wireless networks, and machine learning.

Recent attempts to integrate AI into wireless communication systems have primarily focused on the application layer, network layer, and particularly on wireless resource management and allocation. However, research into integrating AI into wireless communication systems is increasingly evolving towards the MAC layer and the physical layer. In particular, there are emerging attempts to combine deep learning with wireless transmission at the physical layer. AI-based physical layer transmission refers to applying signal processing and communication mechanisms based on AI drivers rather than traditional communication frameworks in fundamental signal processing and communication mechanisms. For example, the AI-based physical layer transmission may include deep learning-based channel coding and decoding, deep learning-based signal estimation and detection, deep learning-based MIMO mechanisms, AI-based resource scheduling and allocation, and the like.

Machine learning may be used for channel estimation and channel tracking. Machine learning can be used for power allocation, interference cancellation, etc. in the DL physical layer. Machine learning may also be used in MIMO systems for antenna selection, power control, and symbol detection.

However, applying deep neural networks for transmission at the physical layer may have the following issues.

Deep learning-based AI algorithms require a large amount of training data to optimize training parameters. However, due to limitations in acquiring data from specific channel environments, a significant amount of training data is often used offline. Static training of training data in specific channel environments may lead to contradictions between the dynamic features and diversity of wireless channels.

Furthermore, current deep learning primarily targets real signals. However, signals at the physical layer of wireless communication are complex signals. More research is needed on neural networks for detecting complex-domain signals to match the characteristics of wireless communication signals.

Hereinafter, machine learning will be described in detail.

Machine learning refers to a series of operations for training machines to perform tasks that are difficult to be performed by human. Machine learning requires data and learning models. In machine learning, data learning methods may be broadly categorized into three types: supervised learning, unsupervised learning, and reinforcement learning.

Neural network learning aims to minimize errors in outputs. Neural network learning refers to a process of repeatedly inputting training data to a neural network, calculating the error of the output and target of the neural network for the training data, backpropagating the error of the neural network from the output layer of the neural network to the input layer to reduce the error, and updating the weight of each neuron of the neural network.

Supervised learning may use training data labeled with a correct answer, whereas unsupervised learning may use training data that is not labeled with a correct answer. For example, in the case of supervised learning for data classification, training data may be labeled with each category. The labeled training data may be input to the neural network, and the output (category) of the neural network may be compared with the label of the training data, thereby calculating the error. The calculated error may be backpropagated through the neural network in reverse (that is, from the output layer to the input layer), and the connection weight(s) of each neuron of each layer of the neural network may be updated based on the backpropagation. Changes in the updated connection weight(s) of each neuron may be determined based on the learning rate. The calculation of the neural network for input data and the backpropagation of the error may configure a learning epoch. The learning data may be applied differently depending on the number of repetitions of the learning epoch of the neural network. For example, in the early phase of learning of the neural network, a high learning rate may be used to increase efficiency such that the neural network rapidly ensures a certain level of performance, but in the late phase of learning, a low learning rate may be used to increase accuracy.

The learning method may vary depending on the feature of data. For example, learning may be performed based on supervised learning rather than unsupervised learning or reinforcement learning to allow a receiver to accurately predict data transmitted from a transmitter in a communication system.

The learning model corresponds to the human brain. To this end, the most basic linear model may be considered. However, a machine learning paradigm that uses highly complex neural network structures such as artificial neural networks as learning models is referred to as deep learning.

Neural network cores used for learning may be broadly categorized into a deep neural network (DNN), a convolutional deep neural network (CNN), and a recurrent neural machine (RNN).

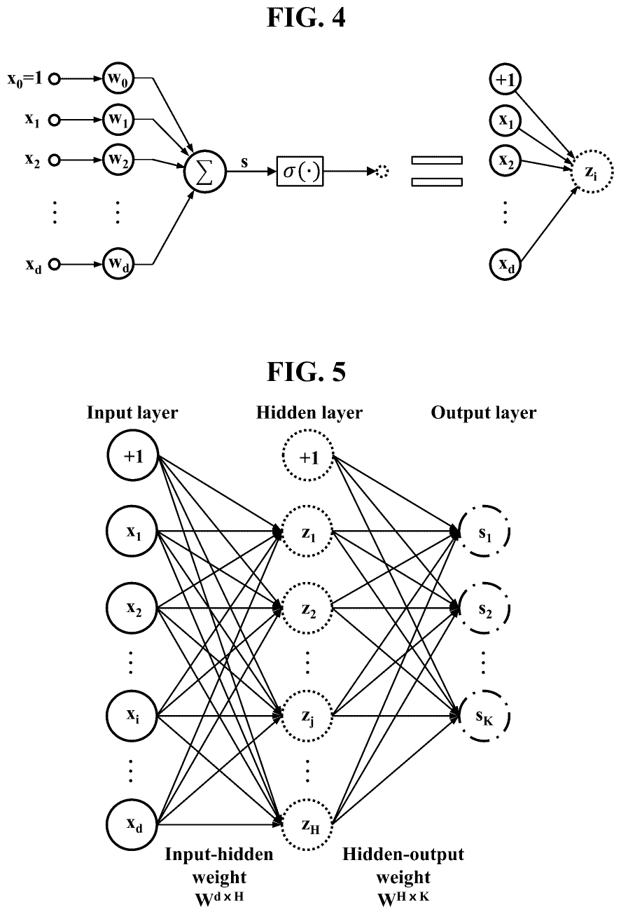

FIG. 4 illustrates a perceptron structure used in an artificial neural network.

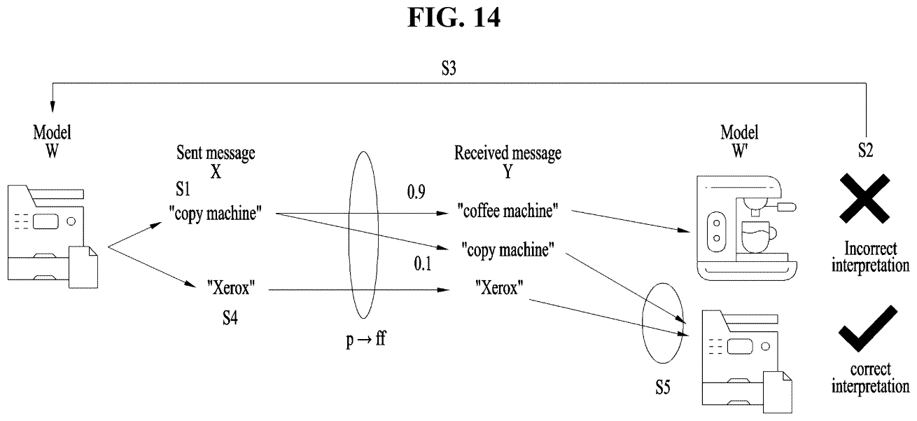

An artificial neural network may be implemented by connecting multiple perceptrons. Referring to FIG. 4, a process of receiving an input vector of x=(x₁, x₂, . . . , x_{d}), multiplying each component by a weight of w=(w₁, w₂, . . . , w_{d}), summing up the results, and then applying an activation function of σ(·) is referred to as a perceptron. For a large artificial neural network structure, the simplified perceptron structure shown in FIG. 14 may be extended. For a large artificial neural network structure, the simplified perceptron structure shown in FIG. 4 may be extended and applied to a multi-dimensional perceptron with different input vectors.

FIG. 5 illustrates a multilayer perceptron structure.

The perceptron structure shown in FIG. 4 may be extended to a multilayer perceptron structure having a total of three layers based on input and output values. An artificial neural network having H perceptrons of (d+1) dimensions between the first and second layers and K perceptrons of (H+1) dimensions between the second and third layers may be represented by the multilayer perceptron structure shown in FIG. 5.

A layer where input vectors are located is called an input layer, a layer where final output value(s) are located is called an output layer, and all layers between the input and output layers are referred to as hidden layers. In the example of FIG. 5, three layers are illustrated. However, since the actual number of layers in an artificial neural network is counted excluding the input layer, the artificial neural network based on the multilayer perceptron structure in FIG. 5 may be considered as having two layers. An artificial neural network is constructed by two-dimensionally connecting perceptrons of basic blocks.

In a neural network, layers are composed of small individual units called neurons. In the neural network, neurons receive inputs from other neurons, perform processing, and produce outputs. A region within the previous layer where each neuron receives inputs is called a receptive field. Each neuron computes output values by applying a specific function to input values received from the receptive field within the previous layer. The specific function applied to the input values is determined by i) a vector of weights and ii) biases. Learning in the neural network is performed based on iterative adjustment of the biases and weights. The vector of weights and the biases are called filters, which represent particular features of the input.

The aforementioned input layer, hidden layer, and output layer may be commonly applied not only to the multilayer perceptron structure but also to various artificial neural network structures such as CNNs, which will be discussed later. As the number of hidden layers increases, the artificial neural network becomes deeper, and the machine learning paradigm that uses sufficiently deep artificial neural networks as learning models is called deep learning. In addition, an artificial neural network used for deep learning are called DNNs.

The aforementioned multilayer perceptron structure is referred to as a fully-connected neural network. In the fully-connected neural network, there are no connections between neurons within the same layer, and connections exist only between neurons in adjacent layers. A DNN, which has the fully-connected neural network structure, includes multiple hidden layers and combinations of activation functions, and thus the DNN may be effectively applied to capture the characteristics of correlation between inputs and outputs. Here, the correlation characteristic may mean the joint probability of inputs and outputs.

On the other hand, various artificial neural network structures distinct from the DNN may be formed depending on how multiple perceptrons are connected to each other.

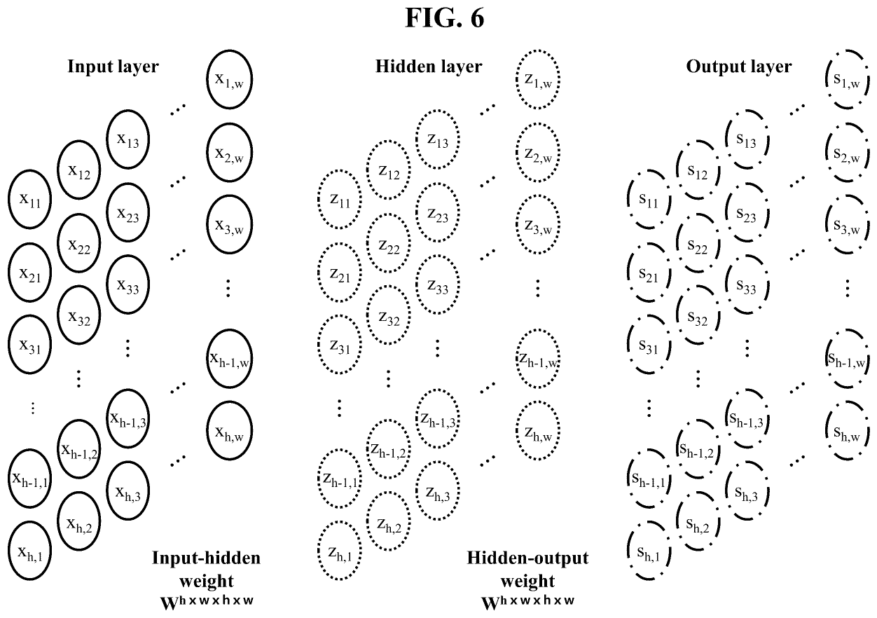

FIG. 6 illustrates the structure of a CNN.

In a DNN, neurons within a layer are arranged in a one-dimensional manner. However, referring to FIG. 6, in the CNN, neurons may be assumed to be arranged in a two-dimensional manner, with w neurons horizontally and h neurons vertically. In this case, since a weight is added for each connection from a single input neuron to hidden layers, a total of h×w weights need to be considered. Since there are h×w neurons in input layers, a total of h²w² weights are required between two adjacent layers.

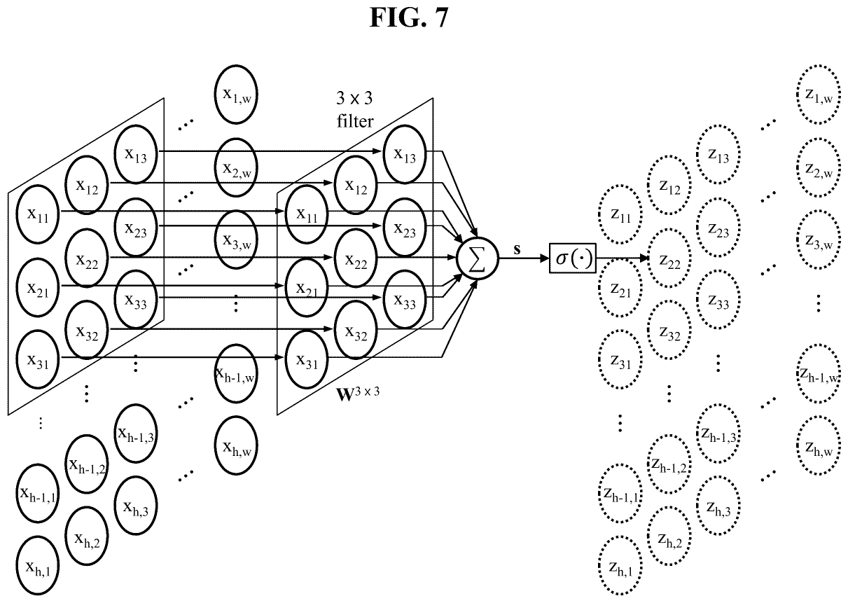

FIG. 7 illustrates a filtering operation in a CNN.

The CNN shown in FIG. 6 faces the issue of an exponential increase in the number of weights depending on the number of connections. Thus, small-sized filters are assumed to exist instead of considering connections between all neurons in adjacent layers. Then, weighted sum and activation function operations are performed on overlapping regions of filter as shown in FIG. 7.

A single filter has weights corresponding to the size of the filter and may undergo learning of the weights such that the filter extracts specific features from an image as factors and produce outputs based on the factors. In FIG. 7, a 3×3 filter is applied to a top-left 3×3 region of an input layer, and an output value obtained by performing the weighted sum and activation function operations on related neurons is stored in z₂₂.

The filter scans the input layer, performs the weighted sum and activation function operations while moving horizontally and vertically at regular intervals, and places the output value at the current position of the filter. This operation method is similar to a convolution operation on images in the field of computer vision. Thus, a DNN with such a structure is called a CNN, and a hidden layer generated by the convolution operation is referred to as a convolutional layer. In addition, a neural network with multiple convolutional layers is called a deep convolutional neural network (DCNN).

In the convolutional layer, the weighted sum is calculated by considering only neuron(s) located within a region covered by the current filter, thereby reducing the number of weights. As a result, a single filter may focus on features within a local region. Therefore, the CNN may be effectively applied to process image data where a physical distance in two-dimensional space is an important criterion. In the CNN, multiple filters may be applied immediately before the convolutional layer, and multiple output results may be produced by convolution operations of each filter.

The CNN may be divided into a part for extracting features from data and a part for classifying classes. In the CNN, the part for extracting features from data (hereinafter referred to as a feature extraction region) may be structured by stacking the following layers multiple times: an essential convolutional layer and an optional pooling layer. As the final part of the CNN, a fully connected layer for classifying classes is added. There is a flattening layer that converts image-type data into an array format between the part for extracting features from data and the part for classifying data.

As described above, the convolutional layer applies filters to input data and then incorporates the activation function, and the pooling layer is positioned after the convolutional layer. In the CNN, filters are also referred to as kernels. In the CNN, the filter performs the convolution operation by traversing the input data at specified intervals. The filter applied in the convolutional layer may create a feature map by moving at the specified intervals and performing the convolution operation on the entirety of the input data. For example, referring to FIG. 7, the output values: z₁₁ to z_{h,w} may constitute the feature map. If multiple filters are applied to the convolutional layer, the convolution operation is performed for each filter, and the feature map may be created based on the sum of convolutions from the multiple filters. The feature map is also referred to as an activation map. In other words, the CNN consist of an input layer, hidden layers, and an output layer. In the CNN, the hidden layers include layers performing convolutions. Typically, the layer performing the convolution computes a dot product between a convolution kernel and the input matrix of the layer, and the activation function of the layer is commonly a rectified linear unit (ReLU). As the convolutional kernel slides over the input matrix of the layer, the convolution operation creates a feature map that contributes to the input of the next layer.

The pooling layer uses output data from the convolutional layer (e.g., feature map) as input data and reduces the size of the input data or emphasizes specific data. In the pooling layer, the following methods are used to process data: max pooling, which collects the maximum value of values within a specific region of a square matrix; average pooling, which calculates the average of values within a specific region of a square matrix; and min pooling, which determines the minimum value of values within a specific region of a square matrix.

The fully connected layer connects every neuron in one layer to every neuron in another layer.

Shannon established the basis for a mathematical theory of communication, deriving conditions that enable reliable transmission of sequences of symbols over noise channels. A demand for a higher data rate has increased to accommodate new incoming services and/or scenarios in which the virtual and real worlds mix. According to current trends, a bottleneck is expected to occur in the near future due to shortages of resources such as spectrum and energy. For example, when a carrier frequency increases, more spaces for a wider bandwidth is generated, but undesirable phenomena such as blocking, atmospheric absorption, and reduced power efficiency may also occur. The following three levels of communication, identified by Shannon and Weaver, have been considered to deal with the challenges posed by these never-ending demands: (i) transmission of symbols (technical issues): (ii) semantic exchange of transmitted symbols (semantic issues); and (iii) effectiveness of semantic information exchange (effectiveness issues).

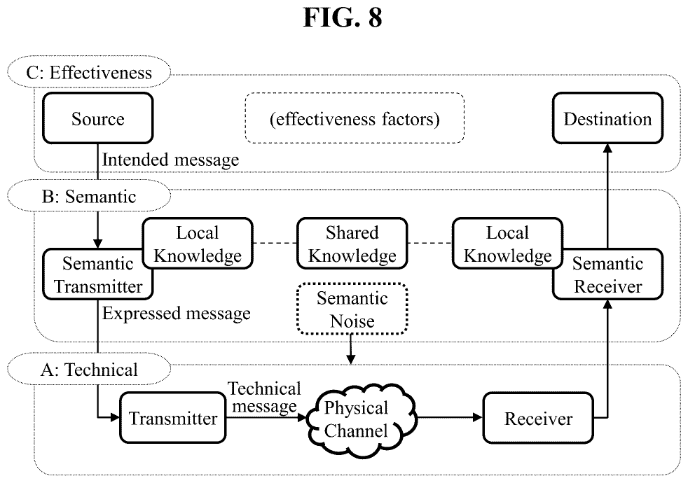

FIG. 8 illustrates a three-level communication model to which implementations of the present disclosure are applicable.

Referring to FIG. 8, the communication model may be defined at three levels A to C. Level A relates to how accurately symbols (technical messages) are to be transmitted between a transmitter and a receiver. The level A may be considered when the communication model is understood from a technical aspect. Level B relates to how accurately the symbols transmitted between a telegraph and a receiver convey the meaning. The level B may be considered when the communication model is understood from a semantic aspect. Level C relates to how effectively the meaning received at a destination contributes to subsequent operations. The level C may be considered when the communication model is understood in terms of effectiveness.

Shannon focused on technical issues and did not consider communication from a semantic aspect. In contrast, Weaver explained that the information theory of Shannon is to be extended to consider the levels B and C, including adding semantic transmitters, semantic receivers, and semantic noise to the communication model of Shannon.

Until 5G communication, technology development was developed focusing only on the level A (i.e., symbol level) for exchanging data. Communication technology research focused on the level A has allowed derivation of a mathematical theory of communication based on probabilistic models. However, for recent networks that emphasize effectiveness and sustainability while enabling pervasive intelligent services, it is no longer justifiable to assume that semantics are irrelevant. In addition to a transmission method, what to transmit also needs to be studied.

Therefore, to respond to a growing need for higher data rates to accommodate new emerging services such as virtual reality or autonomous driving within limited resources such as spectrum and energy, communication model of the level B as well as the level A (the level C) may be considered. In the communication model of the level B, a transmitter and a receiver may be referred to as a semantic transmitter and a semantic receiver, respectively, and semantic noise may be additionally considered.

One of the various goals of 6G communications is to enable a variety of new services that connect machines to people with various levels of intelligence. Not only existing technical issues (e.g., level A in FIG. 8) but also semantic issues (e.g., level B in FIG. 8) need to be considered.

To facilitate understanding, semantic communication is briefly explained below using communication between people as an example. Words for exchanging information (i.e., word information) relate to “meaning.” After hearing what a speaker says, a listener may interpret the meaning or concept expressed by words of the speaker. When this is connected to the communication model of FIG. 8, to support semantic communication, a concept related to a message transmitted from a source need to be correctly interpreted at a destination.

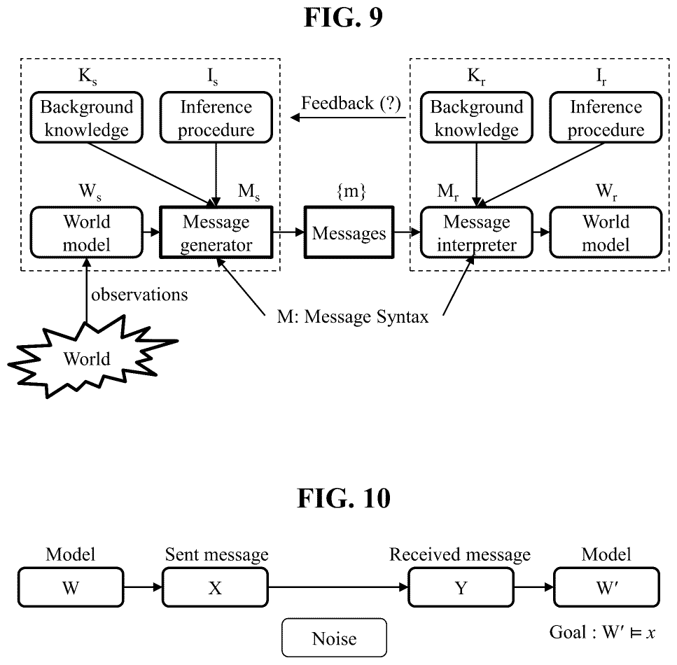

FIG. 9 is a diagram for explaining the characteristics of semantic communication.

Referring to FIG. 9, a source may generate a semantic message through a message generator based on background knowledge Kₛ, world model Wₛ, and inference process Iₛ of meaning to be transmitted (i.e., semantic data). The message generator may generate a semantic message representing semantic data to be transmitted by the source. The semantic message is transmitted to a destination. The destination interprets the semantic message received from the source through a message interpreter based on background knowledge Kᵣ and inference process Iᵣ to obtain semantic data, which is the interpreted message. The destination may perform a specific task (hereinafter referred to as a prediction task) using the semantic data as input and output the result.

Referring to FIG. 9, the Shannon entropy H(W) of the world model W may be represented as follows.

$$H ( W ) = - {\sum }_{w ∈ W} μ ( w ) {log}_{2} μ ( w ) \qquad Equation 1$$

When the world model Wₛ is a set of interpretations with probability distribution u, μ(w) is model distribution, and Wₓ is a set of corresponding models Wₛ with x being true, logical probability m(x) of message x may be represented as follows.

$$m ( x ) = \frac{μ ( {W}_{x} )}{μ ( W )} = \frac{{\sum }_{w ∈ W , w \vert =} μ ( w )}{{\sum }_{w ∈ W} μ ( w )} \qquad Equation 2$$

Semantic entropy Hs(x) of x may be represented as follows.

$${H}_{s} ( x ) = - {log}_{2} ( m ( x ) ) \qquad Equation 3$$

In this case, when background knowledge is considered, Equation 2 and Equation 3 may be represented as conditional probabilities as Equation 4 and Equation 5, respectively.

$$m ( x \vert K ) = \frac{μ ( {W}_{x} )}{μ ( W )} = \frac{{\sum }_{w ∈ W , w \vert = , x} μ ( w )}{{\sum }_{w ∈ W , x \vert = K} μ ( w )} \qquad Equation 4$$

$${H}_{s} ( x \vert K ) = - {log}_{2} ( m ( x \vert K ) ) \qquad Equation 5$$

For example, p is statistical probabilities, and a truth table, which is background knowledge K, is given as shown in the following table. In particular, the following table is an example of a truth table with p(A)=p(B)=0.5 and K={A→B}.

TABLE 1

| # | A | B | A→B | probability |
|---|---|---|---|---|
| 1 | 0 | 0 | 1 | 0.25 |
| 2 | 0 | 1 | 1 | 0.25 |
| 3 | 1 | 0 | 0 | 0.25 |
| 4 | 1 | 1 | 1 | 0.25 |

In the above example, the entropy of the source without considering background knowledge and the model entropy of the source considering background knowledge are each as follows.

$$H ( W ) = - 4 * 0.25 {log}_{2} ( 0.25 ) = 2 \qquad Equation 6$$

$$( W \vert K ) = - 3 * 1 / 3 {log}_{2} ( 1 / 3 ) = 1.585 \qquad Equation 7$$

Equation 6 and Equation 7 show that presence of background knowledge allows the message to be transmitted from the source to be compressed without losing information. As such, one of the main reasons why communication at a semantic level is capable of providing performance improvement related to the existing technical level is that background knowledge is considered.

FIG. 10 shows an example of a semantic communication model considering semantic noise. In FIG. 10, logical symbol |= is double turnstile and x|=y means that x semantically entails y. For example, x|=y means that when all the sentences on the left are true, the sentences on the right need to also be true.

When semantic communication is performed, a semantic error may occur when the destination interprets the semantic message delivered from the source.

Referring to FIG. 10, a semantic error is not a conventional bit error that occurs because a bit sequence restored at the destination is different from a bit sequence transmitted by the source, but refers to a case in which the meaning related to a message interpreted by the destination is the same as the meaning intended by the source. When the result of the destination interpreting a semantic message containing semantic data x delivered by the source through a message interpreter is referred to as semantic data x′, the semantic data x′ is interpreted to be the same as the meaning that the source intended to transmit through the semantic message.

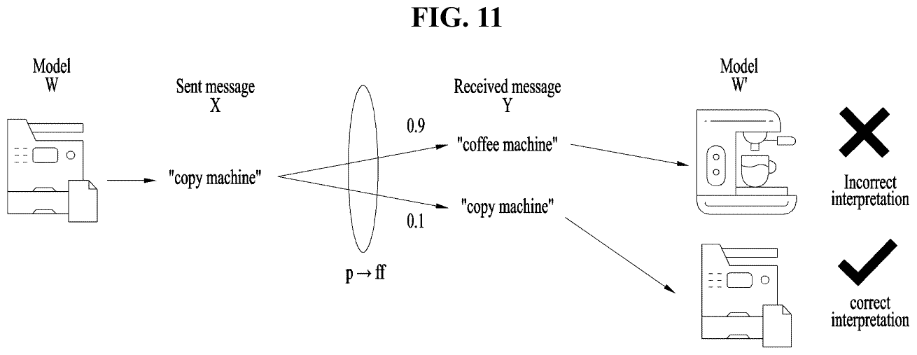

FIG. 11 is a diagram for helping understand semantic errors.

Semantic errors in semantic communication may occur, for example, in the following situations.

### 1) When the Meaning of a Message Changes Due to Technical Noise

For example, referring to FIG. 11, the source transmits “copy machine”, but “p” is changed to “ff” due to technical noise, there is a high probability that “copy machine” is received as “coffee machine” at the destination, and thus there may be a high possibility that the destination interprets the message delivered by the source differently from the intent of the source.

### 2) When Semantic Mismatch Occurs

The background knowledges and inference processes held by the source and the destination may not be the same. Even if the background knowledges and inference processes held by the source and the destination are the same, the background knowledge may be continuously updated, and through this knowledge update, an operation of the corresponding inference process may also be updated to improve performance. Therefore, incorrect interpretation of the message delivered by the source may occur at the destination due to the source and the destination using different background knowledges and/or inference processes.

As described above, in semantic communication, technical noise and semantic mismatch that may affect interpretation of delivered semantic messages need to be considered, and there is a need for a method of correcting semantic errors and restoring semantic data incorrectly interpreted due to semantic mismatch. However, the existing researches either propose a simple model (e.g., Kₛ=Kᵣ, Iₛ=Iᵣ in FIG. 9) while assuming absence of semantic mismatch, or configure an end-to-end system that does not consider feedback. Therefore, in the case of the existing semantic communication, there is no procedure to recover semantic errors when the semantic errors occur at the destination.

Hereinafter, several implementations of the present disclosure in which a semantic message is interpreted correctly at the destination to allow the destination to operate as intended by the source will be described.

In a semantic communication system according to some implementations of the present disclosure, the destination may transmit semantic feedback to the source for recovery of semantic data, and the source, which receives the semantic feedback, transmits a semantic redundancy message to the destination for message recovery.

Some implementations of the present disclosure relate to a semantic level corresponding to level B in FIG. 8, and as in the example in FIG. 9, the source and the destination may include their own world models, background knowledges, inference procedures, message generators, and/or message interpreters, and the source and the destination have the same purpose of prediction tasks that are performed using semantic data obtained through interpretation of semantic messages as input.

First, the source may generate a semantic message containing the meaning to be delivered to the destination and deliver the semantic message to the destination. In this case, when the result of the prediction task performed by the destination by using the received semantic message matches the intent to be delivered by the source, semantic communication may be considered to be performed normally. However, the destination is not capable of checking whether the message received from the source is interpreted correctly when the background knowledges and inference processes do not match, and thus it is necessary to check whether the semantic message is interpreted correctly at the source through semantic feedback.

For semantic feedback, required information needs to be selected from the destination. Referring to FIG. 10, when the semantic data delivered by the source is x and the semantic data obtained from the destination is x′, the following two factors may be considered for semantic feedback:
i) Semantic data x′, which is the result obtained through the message interpreter at the destination, and/or
ii) The result of the prediction task performed with semantic data x′ at the destination as input.

One of the purposes of semantic communication is to accurately deliver meaning, and thus in terms of accurate delivery of meaning, in terms of interpreting the meaning or intent contained in semantic data x′ rather than semantic data x′ itself, which is the result of recovering the received semantic message Y, the result of the prediction task of the destination may be seen as intent to deliver semantic message X to the destination by the source. In terms of reduction in the amount of information transmitted through semantic feedback, the amount of information for information ii) may be equal to or less than for information i). Therefore, in consideration with the above two aspects, in some implementations of the present disclosure, information ii) is delivered to the source as semantic feedback.

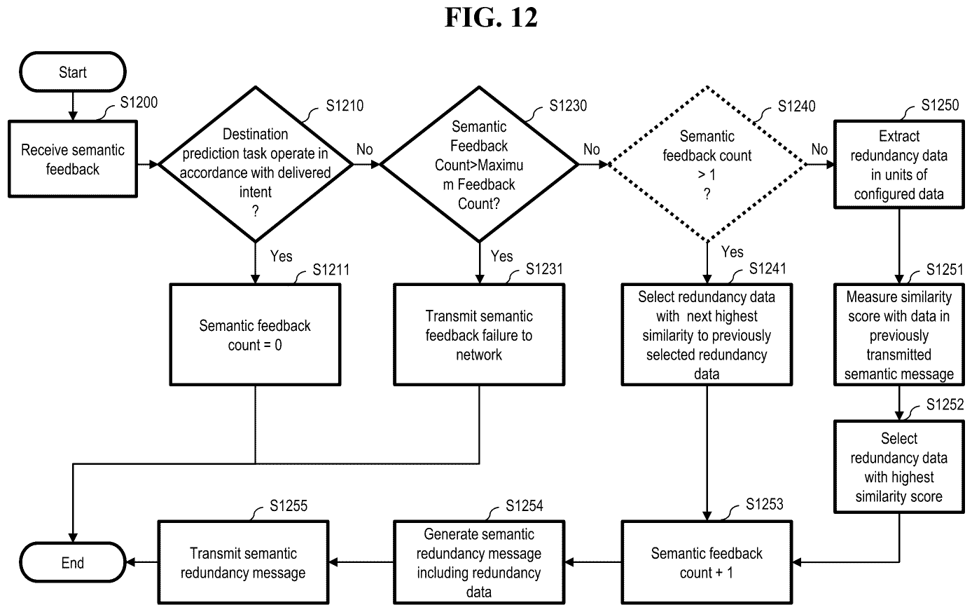

FIG. 12 illustrates operations performed at a source according to some implementations of the present disclosure.

In some implementations of the present disclosure, the source may generate a semantic message containing the meaning to be delivered by the source and deliver the semantic message to the destination.

Referring to FIG. 12, the source may receive semantic feedback from the destination (S1200). The source may determine whether the prediction task is performed at the destination as intended by the source based on the semantic feedback (S1210).

When the prediction task of the destination is performed as intended by the source (Yes in S1210), the source may set the semantic feedback count to 0 (S1211), and when there is new semantic data to be transmitted, the source may generate a next semantic message to be transmitted and transmit the same to the destination. Otherwise (No in S1210), the source may perform a procedure to deliver a semantic redundancy message to allow the destination to correctly interpret the previously transmitted semantic message.

To generate the semantic redundancy message, the source may obtain redundancy data that fits a configured data size by using knowledge the source has (S1250). In some implementations, the source may determine or generate redundancy data when receiving first feedback. For example, when the semantic feedback count=1 (No in S1240), the source may determine or generate redundancy data, and when the semantic feedback count>1 (Yes in S1240), the source may select redundancy data with the next highest similarity after the previously selected redundancy data based on the previously determined or generated redundancy data (S1241). Alternatively, in some implementations, the source may determine or generate redundancy data within the maximum number of semantic feedbacks received during an initial setup process for semantic communication. For example, when the semantic feedback count for the received semantic feedback does not exceed the maximum number of semantic feedbacks (No in S1230), redundancy data may be determined or generated in response to the received semantic feedback (S1250).

The source that extracts or generates redundancy data in a configured data unit may measure a similarity score between the determined/generated redundancy data and semantic (redundancy) data used to generate a previously transmitted semantic message (S1251). In some implementations, a DNN may be appropriately configured according to one of the models shown in the following table for measurement of a similarity score between semantic (redundancy) data represented in previous semantic messages and candidate redundancy data.

TABLE 2

| Model | Main concept |
|---|---|
| Distance | A similarity-based distance (e.g., Euclidean distance/ |
| model | Manhattan distance) is calculated. |
| | For example, in a method of calculating a distance using |
| | an absolute value, a distance L1 between two entities |
| | (e.g., Manhattan distance) in a space called a relation is |
| | calculated as a score: |
| | g(e₁), R, e₂) = \|\|W_{R,1}e₁ − W_{R,2}e₂\|\|, |
| | where W is a parameter for classifying the relation R. |
| Single | A weight parameter W and an input variable X that are |
| layer | used in a single layer are calculated. A non-linear activa- |
| model: | tion function f is used. |
| perceptron model | $g ( {e}_{1} , R , {e}_{2} ) = {u}_{R}^{T} f ( {W}_{R , 1} {e}_{1} + {W}_{R , 2} {e}_{2} ) = {u}_{R}^{T} f ( [ {W}_{R , 1} , {W}_{R , 2} ] [ \begin{matrix}{e}_{1} \\ {e}_{2}\end{matrix} ]$ |
| | Here, f is, for example, a hyperbolic tangent function for non- |
| | linearity, and W and u are parameters for calculating a score |
| | for the relation R. |
| | The above equation is a combination (+) of two entity vectors, |
| | with non-linearity added. |
| Hadamard | The Hadamard product is used to increase the strength of |
| model | interaction between an entity and a relation. |
| | g(e₁, R, e₂) = (W₁e₁⊗W_{rel,1}e_{R} + b₁)^{T} (W₂e₂⊗W_{rel,2}e_{R} + b₂) |
| | For each entity, through the Hadamard product, interaction |
| | with the relations is calculated → the score for the relation |
| | between entity 1 e₁ and entity 2 e₂ is calculated. |
| | All relations share characteristics through parameters W₁, |
| | W₂, Wᵣₑₗ. Here, Wᵣₑₗ is a weight vector for the relation, and e_{R} |
| | is a vector representing the relation between entities. |
| Bilinear | To connect two vector spaces, the two vector spaces are ex- |
| model | pressed as one vector space. This simply means combining |
| | two vector inputs into one vector output. |
| | When representing an entity and a relation as e and R, respec- |
| | tively, it may be possible to represent an interaction between |
| | entities e for each relation R in a relation specific bilinear form. |
| | g(e₁, R, e₂) = e₁^{T}W_{R}e₂ |
| | Generation of a bilinear form means performing some kind of |
| | representation. |

For example, the similarity calculation models shown in Table 2 may be used to determine similarity in some implementations of the present disclosure. In Table 2, eᵢ represents entity i, which is a comparison target, and may be represented in vector form. In Table 2, R represents a relation between entities, and parameters W and biases b for the models in Table 2 may be obtained through DNN learning. Table 2 is only an example, and the similarity score may be obtained using various other methods.

According to the configuration of the model that measures the similarity score, in some models, similarity may be determined to be high when a score is high, and conversely, in some models, similarity may be determined to be high when the similarity score is low.

The source may compare similarity scores for respective redundancy data obtained through similarity score measurement to select redundancy data with the highest similarity (S1252), generate a semantic message with the selected redundancy data (S1254), and lastly, deliver a semantic redundancy message containing intent of the selected redundancy data to the destination (S1255).

In some implementations, the source may increase the semantic feedback count by 1 based on selecting redundancy data (S1253). In the example of FIG. 12, the semantic feedback count is increased after redundancy data is selected, but an order in which the semantic feedback count is increased may be different from the example of FIG. 12. For example, in some implementations, the source may increase the semantic feedback count by 1 before comparing the semantic feedback count with a predetermined maximum semantic feedback count (S1230). Alternatively, in some implementations, the source may increase the semantic feedback count by 1 when generating a semantic redundancy message containing redundancy data or transmitting the semantic redundancy message.

The destination receiving the semantic redundancy message may obtain semantic data through the message interpreter based on the previously received semantic message and the semantic redundancy message, and then deliver the semantic data obtained through the message interpreter to the prediction task to obtain the result of prediction task and to deliver the corresponding result back to the source. The source receiving the result of the prediction task performed by the destination may determine whether the prediction task is performed as intended by the source. When the result of the prediction task performed by the destination matches intent of the source, the source may generate a (new) semantic message to be transmitted next and transmit the generated message to the destination, and otherwise, the source may select redundancy data with the highest similarity, which is next to the similarity of the previously delivered redundancy data, from among the determined/generated candidate redundancy to generate a semantic redundancy message and then deliver the generated semantic redundancy message to the destination. This operation may be performed repeatedly until the semantic message is recovered within a set number of semantic feedbacks.

When the semantic feedback is delivered from the destination to the source to exceed the set number of semantic feedbacks (Yes in S1230), the source may transmit a semantic feedback failure to a network (S1231). Through to the semantic feedback failure, the network may be requested to reconfigure semantic communication-related operation(s) between the source and the destination.

The order of some operations illustrated in FIG. 12 may be changed or may be omitted depending on settings.

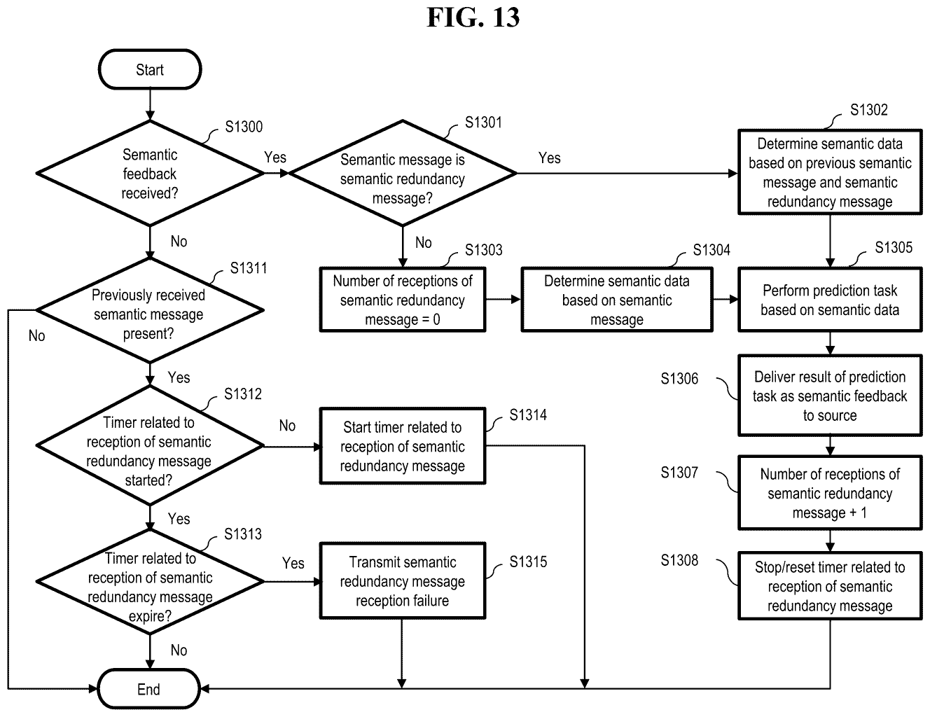

FIG. 13 illustrates operations performed at a destination according to some implementations of the present disclosure.

Referring to FIG. 13, a semantic message may be received at the destination that transmits semantic feedback (Yes in S1300).

When the currently received semantic message is a semantic redundancy message (Yes in S1301), the destination may obtain semantic data through a message interpreter based on the previously received semantic message and the semantic redundancy message (S1302).

When the currently received semantic message is not a semantic redundancy message (No in S1301), for example, when the number of receptions of semantic redundancy=0 (S1303), the destination may determine semantic data through the message interpreter based on the currently received semantic message (S1304).

The destination may perform a prediction task by using the semantic data obtained through the message interpreter as input to obtain a result of the prediction task (S1305) and deliver the corresponding result back to the source (S1306).

In some implementations of the present disclosure, the destination may store the number of receptions of semantic redundancy messages and increase the reception count for the semantic redundancy messages by 1 whenever a semantic redundancy message is received (S1307). When the destination receives a new semantic message representing new semantic data that is different from or unrelated to previously received semantic data, the destination may set the reception count for semantic redundancy messages to 0 (S1303). In some implementations of the present disclosure, the destination may use a timer related to reception of a semantic redundancy message, and the destination may start/restart the timer when transmitting the semantic feedback. The destination may stop and/or reset the timer upon receiving a semantic redundancy message in response to semantic feedback (S1308).

The destination transmitting the semantic feedback may not receive the semantic message within a certain period of time (No in S1300). When a previously received semantic message exists at the destination that does not receive the semantic message after the semantic feedback is transmitted (Yes in S1311), a timer related to receiving of the semantic redundancy message starts (Yes in S1312), and the timer related to receiving of the semantic redundancy message expires (Yes in S1313), the destination may transmit a semantic redundancy message reception failure to the network (S1315). When a previously received semantic message exists at a destination that does not receive a semantic message after the semantic feedback is transmitted (Yes in S1311), but the timer related to receiving of the semantic redundancy message does not start (No in S1312), the destination may start the timer related to receiving of the semantic redundancy message (S1314).

In some implementations, the destination may transmit semantic feedback to the source within a set number of semantic feedbacks. In some implementations, after the semantic feedback is transmitted, when a new semantic message is received that is not of a size corresponding to the semantic redundancy message (different from the semantic data obtained by interpreting the previously received semantic message), the destination may determine that the prediction task performed based on previous semantic data is successfully completed.

In some implementations, when the destination transmitting the semantic feedback to the source a set number of semantic feedbacks does not receive a semantic redundancy message within a certain period of time after transmitting the last semantic feedback, the destination may transmit a semantic communication failure to the network and transmit a semantic communication failure to the source to request re-establishment of semantic communication between and the destination.

The order of some operations illustrated in FIG. 13 may be changed or may be omitted depending on settings.

Hereinafter, some implementations of the present disclosure are explained again with reference to a text-related example and a graph-related example.

### Text-Related Example

FIG. 14 is diagram for explaining some implementations of the present disclosure using text data as an example. FIG. 14 shows an example to explain a process for delivering a semantic feedback/redundancy message for recovery of a semantic message in text-based semantic communication, according to some implementations of the present disclosure.

Based on a large amount of corpus, the source may represent the text as a semantic message (e.g., a sentence) and deliver the text to the destination. Like the source, the destination interprets the meaning of the message delivered by the source through a message interpreter using a large amount of corpus owned by the destination. As in the example of FIG. 11, in the example of FIG. 14, an environment in which the source transmits “copy machine”, but “p” is changed to “ff” due to technical noise, and there is a high-probability that “copy machine” is received as “coffee machine” at the destination may be assumed.

In the example of FIG. 14, semantic communication according to some implementations of the present disclosure may be performed as follows.
S1) When the source intends to inform the destination of an image corresponding to a copier, the source may generate and transmit a semantic message representing the image of the copier as “copy machine” text.
S2) The destination may obtain semantic data through the message interpreter based on the received semantic message Y, deliver the obtained semantic data to the prediction task, and check whether the result of the prediction task is interpreted as intended by the source. However, due to a technical error in which “p” changes to “ff”, when the results obtained through the message interpreter are “coffee machine” with a probability of 0.9 and “copy machine” with a probability of 0.1, the result of the prediction task may be “coffee machine” with the highest probability.
S3) The destination may transmit the results obtained in S2 to the source as semantic feedback.
S4) The source receiving the semantic feedback may check that the semantic message transmitted by the source is not interpreted as “copy machine” by the destination and determine or generate redundancy data. In this case, the source may determine redundancy data in keyword units from a large amount of corpus held by the source and measure a similarity score between the corresponding keyword and the “copy machine.” Based on the similarity measurement, the source may select “Xerox” with the highest similarity to generate a semantic message (i.e., generate a semantic redundancy message representing or carrying “Xerox”), and transmit the semantic message to the destination.
S5) The destination receiving the semantic redundancy message may obtain a message by using the message interpreter with the previously received semantic message and deliver the message to the prediction task, and thus recognize the message as “copy machine”.

The destination may transmit the result of S5 to the source as semantic feedback as in S3. The source receives the semantic feedback and identifies the “copy machine” intended by the source from the semantic feedback. When there is text data to be transmitted next in the source, the text data may be generated as a semantic message and transmitted. The destination receiving the (new) text data performs operations S2 to S3.

### Graph-Related Example

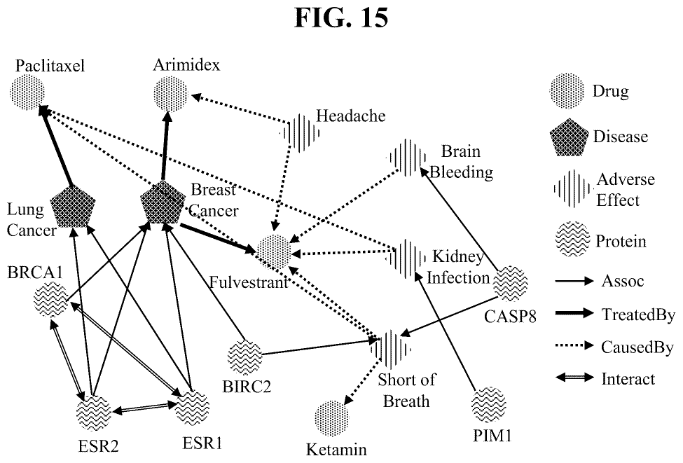

FIGS. 15 to 18 are diagrams for explaining some implementations of the present disclosure using graph data as an example. Hereinafter, implementations of the present disclosure will be described taking as an example the case in which the background knowledge of the source and the destination is a bio-knowledge graph.

The source and the destination may have knowledge in the form of a graph, and operations of the inference process, message generator, and/or message interpreter may also proceed in the form of representing and inference about the graph data.

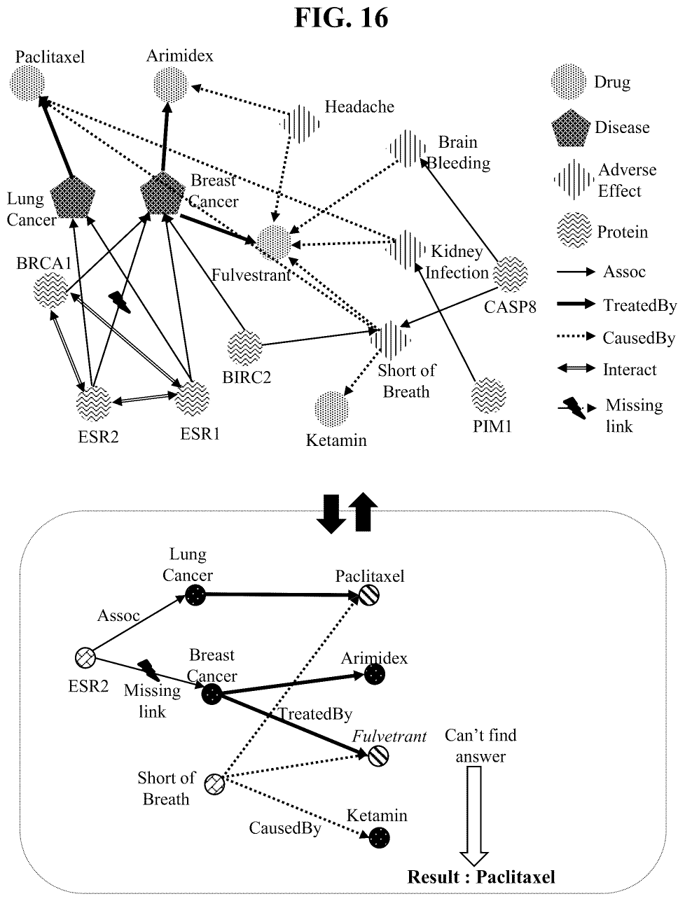

The source may have background knowledge in the form of the bio knowledge graph illustrated in FIG. 15, and the destination may have background knowledge in the form of the bio knowledge graph illustrated in FIG. 16.

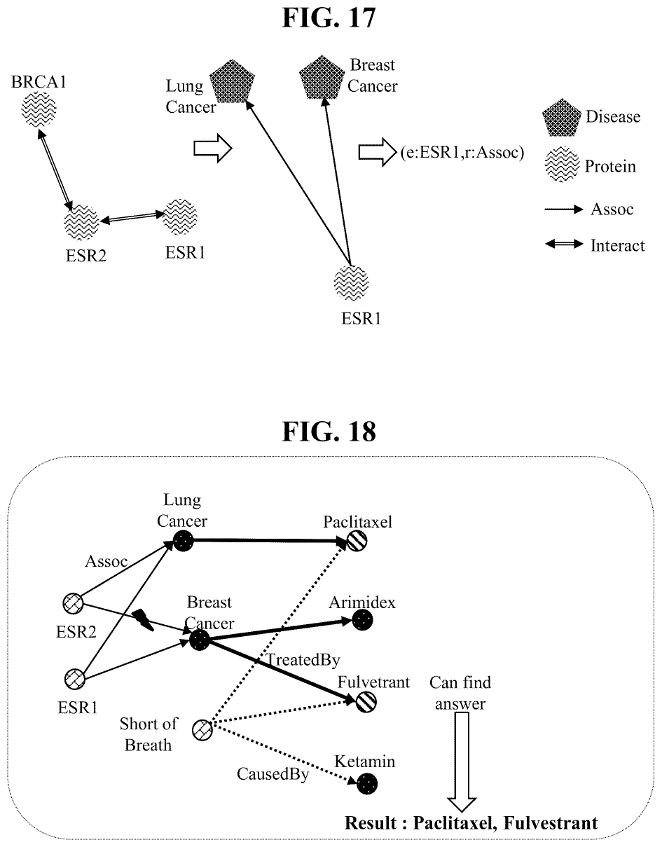

Based on the bio knowledge graph illustrated in FIG. 15, semantic communication according to some implementations of the present disclosure may be performed as follows. In the following message expressions described with reference to FIGS. 15 to 18, nodes (i.e. entities) constituting a knowledge graph are denoted by e, and connection (i.e. link) representing connections between nodes is denoted by r.
S1) The source may configure a semantic message in the form of a query containing the meaning the source intends to deliver. In particular, hereinafter, conjunctive queries are used as an example from among various types of queries, and it is assumed that the source intends the result of the corresponding query as the result of the prediction task.
S2) The source represents the query “What are drugs that cause Short of Breath and treat diseases associated with protein ESR2?” in the form of an expression to transmit a semantic message. When the corresponding query is represented by being mapped to the knowledge graph, it may be represented as follows: ((e:ESR2, (r:Assoc, r:Treatedby)), (e:Short of Breath, (r:causedBy)). That is, the source may generate a query “What are drugs that cause Short of Breath and treat diseases associated with protein ESR2?” which is semantic data as a semantic message including indication ((e:ESR2, (r:Assoc, r:Treatedby)), (e:Short of Breath, (r:causedBy)) through a message generator. In this case, the results of the prediction task of the destination as intended by the source are “Paclitaxel” and “Fulvestrant” from among drugs.
S3) The source delivers the semantic message to the destination.
S4) The destination obtains semantic data from the semantic message received by the destination by using the background knowledge and inference process held by the destination in the message interpreter of the destination.
S5) The destination interprets the received semantic message and delivers the obtained semantic data to the prediction task to derive a result. For example, the destination may generate indication ((e:ESR2, (r:Assoc, r:Treatedby)), (e:Short of Breath, (r:causedBy)) including the received semantic message as a query “What are drugs that cause Short of Breath and treat diseases associated with protein ESR2?” which is semantic data, through the message interpreter. The destination may perform a prediction task for “What are drugs that cause Short of Breath and treat diseases associated with protein ESR2?”. When the destination has the knowledge as in FIG. 16, there is no link between ESR2 and “Breast Cancer”. Therefore, as illustrated in FIG. 17, the destination may not derive “Fulvestrant” as a result of the prediction task of the destination, but may derive only “Paclitaxel”.
S6) The destination may transmit the result of the prediction task of the destination (e.g., “Drug-Paclitaxel”) to the source as semantic feedback.
S7) The source receiving the semantic feedback may compare the result of the prediction task intended by the source with the result of the prediction task by the destination and check that only one drug “Fulvestrant” rather than two drugs “Paclitaxel” and “Fulvestrant” intended by the source is derived by the destination.
S8) When the result of the prediction task intended by the source is different from the result of the prediction task performed by the destination, the source may perform a task of obtaining redundancy data from background knowledge based on the meaning the source originally intends to deliver. In this case, referring to FIG. 15, ESR2 has an interaction relation with BRCA1 and ESR1, and thus when a similarity in a subgraph unit question including BRCA1 and/or ESR1 with a previously delivered query is determined, the similarity may be high. The source selects the query with the highest similarity to s subgraph represented by a previously delivered query from among several subgraphs and represent the query in the form of an expression for transmission as a semantic redundancy message. For example, when a subgraph corresponding to the selected redundancy data is expressed, a query corresponding to the semantic redundancy data is as follows: “ESR1 is associated with Breast Cancer”.
S9) The source delivers a semantic redundancy message (e:ESR1, r:Assoc) represented including semantic redundancy data to the destination.
S10) Referring to FIG. 18, the destination receiving the semantic redundancy message may deliver the semantic message as the prediction task to derive “Paclitaxel” and “Fulvestrant” from among drugs as the result of the prediction task after obtaining semantic data through the message interpreter by using the semantic redundancy message with the previously received semantic message and the background knowledge and inference process held by the destination.
S11) The destination transmits the result of S10 as semantic feedback.
S12) The source receives semantic feedback and compares the result of the prediction task performed by the destination with the result of the prediction task intended by the source. When the result of the prediction task performed by the destination is different from the result of the prediction task intended by the source, S8 to S11 may be repeatedly performed within a range not exceeding a predetermined number of attempts. According to the example of FIG. 18, it may be seen that the drugs “Paclitaxel” and “Fulvestrant” intended by the source are normally derived from the destination.
S13) When the result of the prediction task performed by the destination is the same as the result of the prediction task intended by the source, if it is possible to represent a query to be transmitted next in the form of a subgraph of the knowledge graph, the source may generate and transmit a new semantic message based on the corresponding query. The process described above may be performed for the query to be transmitted next until the prediction task is properly performed.

In some implementations of the present disclosure, a problem that occurs when the meaning intended by the source through a semantic message is not properly delivered to the destination due to a semantic error may be resolved.

In some implementations of the present disclosure, the source and the destination may each be a UE. In some implementations of the present disclosure, one of the source and the destination may be a UE and the other may be a network (e.g., BS or server). In some implementations of the present disclosure, configuration/reconfiguration for semantic communication may be provided to the UE by the network.

A transmitting device may perform operations according to several implementations of the present disclosure in relation to transmitting semantic data. In some implementations of the present disclosure, the transmitting device may include: at least one transceiver; at least one processor; and at least one computer memory operably connected to the at least one processor and configured to store instructions that, when executed, cause the at least one processor to perform the operations according to some implementations of the present disclosure. In some implementations of the present disclosure, the transmitting device, a processing device for the communication device may include: at least one processor; and at least one computer memory operably connected to the at least one processor and configured to store instructions that, when executed, cause the at least one processor to perform the operations according to some implementations of the present disclosure. A computer-readable (non-transitory) storage medium may be configured to store at least one computer program including instructions that, when executed by at least one processor, cause the at least one processor to perform the operations according to some implementations of the present disclosure. A computer program or computer program product may include instructions stored on at least one computer-readable (non-transitory) storage medium and, when executed, cause (at least one processor) to perform the operations according to some implementations of the present disclosure.

In the transmitting device, the processing device, the computer-readable (non-transitory) storage medium, and/or the computer program product, the operations may include determining a first semantic message including semantic data to a receiving device, receiving first semantic feedback for the first semantic message from the receiving device, and transmitting a second semantic message including first redundancy data related to the semantic data based on that a result included in the first semantic feedback does not match a result intended by the transmitting device through the first semantic message.

In some implementations, the operations may include further receiving second semantic feedback for the second semantic message from the receiving device.

In some implementations, the operations may include transmitting a new semantic message including new semantic data based on the result included in the first semantic feedback does not match the result intended by the transmitting device through the first semantic message.

In the operation according to some implementations, transmitting the second semantic message including the first redundancy data related to the semantic data to the receiving device may include generating a plurality of redundancy data related to the semantic data in predetermined units, and selecting redundancy data with the highest similarity to the semantic data included in the first semantic message from among the plurality of redundancy data as the first redundancy data.

In some implementations, the operations may include further receiving a configuration for semantic communication. In some implementations, the configuration may include the predetermined unit. In some implementations, the configuration may include information about a similarity function for calculating a similarity.

The receiving device may perform operations according to several implementations of the present disclosure in relation to receiving semantic data. In some implementations of the present disclosure, the receiving device may include: at least one transceiver; at least one processor; and at least one computer memory operably connected to the at least one processor and configured to store instructions that, when executed, cause the at least one processor to perform the operations according to some implementations of the present disclosure. In some implementations of the present disclosure, the receiving device, a processing device for the communication device may include: at least one processor; and at least one computer memory operably connected to the at least one processor and configured to store instructions that, when executed, cause the at least one processor to perform the operations according to some implementations of the present disclosure. A computer-readable (non-transitory) storage medium may be configured to store at least one computer program including instructions that, when executed by at least one processor, cause the at least one processor to perform the operations according to some implementations of the present disclosure. A computer program or computer program product may include instructions stored on at least one computer-readable (non-transitory) storage medium and, when executed, cause (at least one processor) to perform the operations according to some implementations of the present disclosure.

In the receiving device, the processing device, the computer-readable (non-transitory) storage medium, and/or the computer program product, the operations may include receiving a first semantic message including semantic data from a transmitting device, performing a task based on the semantic data, and transmitting first semantic feedback for the first semantic message to the transmitting device, and in this case, the first semantic feedback may include a result of the task performed based on the semantic data.

In some implementations, the operations may include receiving a second semantic message including first redundancy data related to the semantic data, performing a task related to the semantic data based on the semantic data and the first redundancy data, and transmitting second semantic feedback including a result of the task performed based on the semantic data and the first redundancy data to the transmitting device.

The examples of the present disclosure as described above have been presented to enable any person of ordinary skill in the art to implement and practice the present disclosure. Although the present disclosure has been described with reference to the examples, those skilled in the art may make various modifications and variations in the example of the present disclosure. Thus, the present disclosure is not intended to be limited to the examples set for the herein, but is to be accorded the broadest scope consistent with the principles and features disclosed herein.

The implementations of the present disclosure may be used in a BS, a UE, or other equipment in a wireless communication system.

1. A method of transmitting semantic data by a transmitting device in a wireless communication system, the method comprising:
transmitting a first semantic message including the semantic data to a receiving device;
receiving first semantic feedback for the first semantic message from the receiving device; and
transmitting a second semantic message including first redundancy data related to the semantic data to the receiving device based on a result included in the first semantic feedback not matching a result intended by the transmitting device through the first semantic message.

2. The method of claim 1, further comprising:
receiving second semantic feedback for the second semantic message from the receiving device.

3. The method of claim 1, further comprising:
transmitting a new semantic message including new semantic data based on a result included in the first semantic feedback matching a result intended by the transmitting device through the first semantic message.

4. The method of claim 1, wherein transmitting the second semantic message including the first redundancy data related to the semantic data to the receiving device includes:
generating a plurality of redundancy data related to the semantic data in predetermined units; and
selecting redundancy data with a highest similarity to the semantic data included in the first semantic message from among the plurality of redundancy data as the first redundancy data.

5. The method of claim 4, further comprising:
receiving a configuration for semantic communication,
wherein the configuration includes the predetermined units.

6. The method of claim 5, wherein the configuration includes information about a similarity function for calculation of a similarity.

7. A transmitting device for transmitting semantic data in a wireless communication system, the transmitting device comprising:
at least one transceiver;
at least one processor; and
at least one computer memory operably connected to the at least one processor and configured to store instructions that, when executed, cause the at least one processor to perform operations including:
transmitting a first semantic message including the semantic data to a receiving device;
receiving first semantic feedback for the first semantic message from the receiving device; and
transmitting a second semantic message including first redundancy data related to the semantic data to the receiving device based on a result included in the first semantic feedback not matching a result intended by the transmitting device through the first semantic message.

8. A processing device for a communication device, the processing device comprising:
at least one processor; and
at least one computer memory operably connected to the at least one processor and configured to store instructions that, when executed, cause the at least one processor to perform operations including:
transmitting a first semantic message including semantic data to a receiving device;
receiving first semantic feedback for the first semantic message from the receiving device; and
transmitting a second semantic message including first redundancy data related to the semantic data to the receiving device based on a result included in the first semantic feedback not matching a result intended by the transmitting device through the first semantic message.

9. A computer-readable storage medium for storing at least one program code including instructions that, when executed, cause the at least one processor to perform operations comprising:
transmitting a first semantic message including semantic data to a receiving device;
receiving first semantic feedback for the first semantic message from the receiving device; and
transmitting a second semantic message including first redundancy data related to the semantic data to the receiving device based on that a result included in the first semantic feedback not matching a result intended by the transmitting device through the first semantic message.

10. A method of receiving semantic data by a receiving device in a wireless communication system, the method comprising:
receiving a first semantic message including the semantic data from a transmitting device;
performing a task based on the semantic data; and
transmitting first semantic feedback for the first semantic message to the transmitting device,
wherein the first semantic feedback includes a result of a task performed based on the semantic data.

11. The method of claim 10, further comprising:
receiving a second semantic message including first redundancy data related to the semantic data;
performing a task related to the semantic data based on the semantic data and the first redundancy data; and
transmitting second semantic feedback including the result of the task performed based on the semantic data and the first redundancy data to the transmitting device.

12. A receiving device for receiving semantic data in a wireless communication system, the receiving device comprising:
at least one transceiver;
at least one processor; and
at least one computer memory operably connected to the at least one processor and configured to store instructions that, when executed, cause the at least one processor to perform operations including:
receiving a first semantic message including the semantic data from a transmitting device;
performing a task based on the semantic data; and
transmitting first semantic feedback for the first semantic message to the transmitting device,
wherein the first semantic feedback includes a result of a task performed based on the semantic data.
